(19) United States
(12) Patent Application Publication
(10) Pub. No.: US 2011/0305923 A1
(43) Pub. Date: Dec. 15, 2011

(54) UTILIZING POLYMER STRUCTURES IN PLANARIZED MAGNETIC MEDIA

(76) Inventors: Thomas E. Karis, Aromas, CA (US); Charles M. Mate, San Jose, CA (US)

(21) Appl. No.: 12/815,267

(22) Filed: Jun. 14, 2010

(51) Int. Cl. B05D 5/12; B44C 1/22; G11B 5/33; B05D 3/06

(52) U.S. Cl. 428/800; 427/127; 427/558; 216/22

(57) ABSTRACT

Magnetic recording disks and associated fabrication methods are described for utilizing polymer structures in planarized magnetic media. A polymer fill material is deposited on the disk and a removal process is performed on the fill material to planarize the disk. In some embodiments, the fill material is deposited subsequent to bonding a lubrication layer to a protective layer on the disk. In other embodiments, the fill material is bonded directly to a protective layer on the disk.

### FIELD OF THE INVENTION

The invention is related to the field of magnetic disks, and in particular, to planarizing patterned magnetic disks utilizing polymer structures.

### BACKGROUND

Many computer systems use magnetic disk drives for mass storage of information. Magnetic disk drives typically include one or more sliders having a read head and a write head. An actuator/suspension arm holds the slider above the surface of a magnetic disk. When the disk rotates, an air flow generated by the rotation of the disk causes an air bearing surface (ABS) side of the slider to fly to a particular height above the disk. As the slider flies on the air bearing, a voice coil motor (VCM) moves the actuator/suspension arm to position the read/write head over selected tracks of the disk. The read/write head may then read data from or write data to the tracks of the disk.

A conventional disk includes data fields where the actual data is stored. In the data fields, the magnetic surface of the disk is divided into small magnetic regions, each of which is used to encode a single binary bit of information. The magnetic regions include a few dozen magnetic grains forming a magnetic dipole, which generates a highly localized magnetic field. The write head magnetizes a magnetic region by generating a strong local magnetic field to store a bit of data within the magnetic region during a write process. The read head senses the magnetic dipole of the magnetic region to read the bit of data during a read process.

As the areal bit density of the disk increases, the super-paramagnetic effect causes reliability problems for magnetic data storage. The super-paramagnetic effect occurs when the magnetic regions on the disk become so tiny that ambient temperature can reverse the orientation of their magnetic dipole. The result is that the bit is reversed and the data encoded by the bit is corrupted.

One solution to the problems posed by the super-paramagnetic effect is to pattern the disk. A patterned disk is created as an ordered array of discrete magnetic lands between grooves with some depth and with each land capable of storing an individual bit.

One consequence of using unplanarized patterned disks is that the depth created when patterning the disk causes a disturbance in the spacing between the read/write heads and the surface of the disk. This problem arises as, when the slider flies over the disk with the desired clearance between the head and land areas, the presence of unfilled grooves results in increasing the mean flying height, which leads to a larger modulation of the clearance between the read/write heads and the surface of the disk than for smooth disks. This modulation of the clearance and magnetic spacing degrades the quality of reading data from or writing data to the disk. To planarize these disks a fill material may be deposited within the grooves of the patterned disk to reduce the variations in depth between the top of the lands and the bottom of the grooves. However, known polymer fill materials may be inadequate due to shrinkage and recession in the grooves, which may ultimately render the disk poorly planarized.

### SUMMARY

Embodiments provided herein include depositing a perfluoropolyether polymer fill material on a patterned magnetic disk and performing a removal process on the fill material to planarize the disk. In some embodiments, the fill material is a perfluoropolyether backbone coupled to a cross-linkable end and/or side group with a urethane linkage, which provides exceptional planarization results on patterned media. In these embodiments, the fill material is bonded directly to a protective layer on the disk. In other embodiments, the fill material is deposited subsequent to bonding a lubrication layer to a protective layer on the disk.

One embodiment comprises a method of fabricating a patterned magnetic recording disk. According to the method, a fill material is deposited on the magnetic recording disk. In one embodiment, the fill material is a polymer comprising a perfluoropolyether backbone coupled to a cross-linkable end and/or side group using a urethane linkage. In another embodiment, the fill material is a perfluoropolyether backbone coupled to non-cross-linkable functional groups. A removal process is performed on the fill material to planarize the magnetic recording disk. In some embodiments, a protective layer is deposited on a patterned magnetic recording layer of the magnetic recording disk. A lubrication layer is deposited on the protective layer, and bonded to the protective layer. The fill material is deposited on the lubrication layer.

Another embodiment comprises an alternate method of fabricating a patterned magnetic recording disk. According to the method, a protective layer is deposited on a patterned magnetic recording layer of the disk. A fill material is deposited on the protective layer. The fill material is a polymer comprising a perfluoropolyether backbone coupled to a cross-linkable end and/or side group using a urethane linkage. The fill material is bonded to the protective layer. A removal process is performed on the fill material to planarize the magnetic disk. In some embodiments, a lubrication layer is deposited on the magnetic recording disk and bonded to the fill material. Other exemplary embodiments may be described below:

### DESCRIPTION OF THE DRAWINGS

Some embodiments of the present invention are now described, by way of example only, and with reference to the accompanying drawings. The same reference number represents the same element or the same type of element on all drawings.

FIG. 1 is a flow chart illustrating a method of fabricating a patterned magnetic disk in an exemplary embodiment.

FIG. 2 is a cross-sectional view illustrating the disk after depositing a protective layer on a patterned magnetic recording layer according to an optional step of the method of FIG. 1.

FIG. 3 is a cross-sectional view illustrating the disk after depositing and bonding a lubrication layer on the protective layer according to optional steps of the method of FIG. 1.

FIG. 4 is a cross-sectional view illustrating the disk after depositing a fill material on the lubrication layer according to a step of the method of FIG. 1.

FIG. 5 is a cross-sectional view illustrating the disk after performing a removal process on the fill material according to a step of the method of FIG. 1.

FIG. 6 is a flow chart illustrating an alternate method of fabricating a patterned magnetic recording disk in an exemplary embodiment.

FIG. 7 is a cross-sectional view illustrating the disk after depositing a protective layer on a patterned magnetic recording layer according to a step of the method of FIG. 6.

FIG. 8 is a cross-sectional view illustrating the disk after depositing and bonding a fill material on the protective layer according to steps of the method of FIG. 6.

FIG. 9 is a cross-sectional view illustrating the disk after removing excess fill material according to an optional step of the method of FIG. 6.

FIG. 10 is a cross-sectional view illustrating the disk after performing a removal process on the fill material according to an optional step of the method of FIG. 6.

FIG. 11 is a cross-sectional view illustrating the disk after depositing a lubrication layer on the disk according to an optional step of the method of FIG. 6.

FIG. 12 is a flow chart illustrating an alternate method of fabricating a patterned magnetic recording disk in an exemplary embodiment.

FIG. 13 is a cross-sectional view illustrating the disk after depositing a protective layer on a patterned magnetic recording layer according to a step of the method of FIG. 12.

FIG. 14 is a cross-sectional view illustrating the disk after depositing and bonding a lubrication layer on the protective layer according to steps of the method of FIG. 12.

FIG. 15 is a cross-sectional view illustrating the disk after depositing a fill material on the lubrication layer according to a step of the method of FIG. 12.

FIG. 16 is a cross-sectional view illustrating the disk after removing excess fill material according to a step of the method of FIG. 12.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

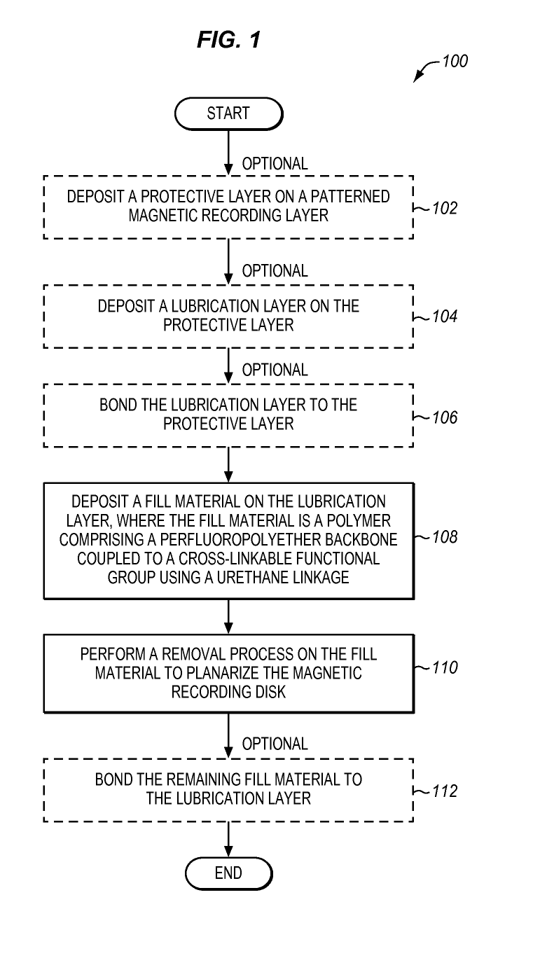

FIG. 1 is a flow chart illustrating a method 100 of fabrication a patterned magnetic recording disk in an exemplary embodiment. The steps of the flow charts provided herein are not all inclusive and other steps, not shown, may be included. Further, the steps may be performed in an alternative order.

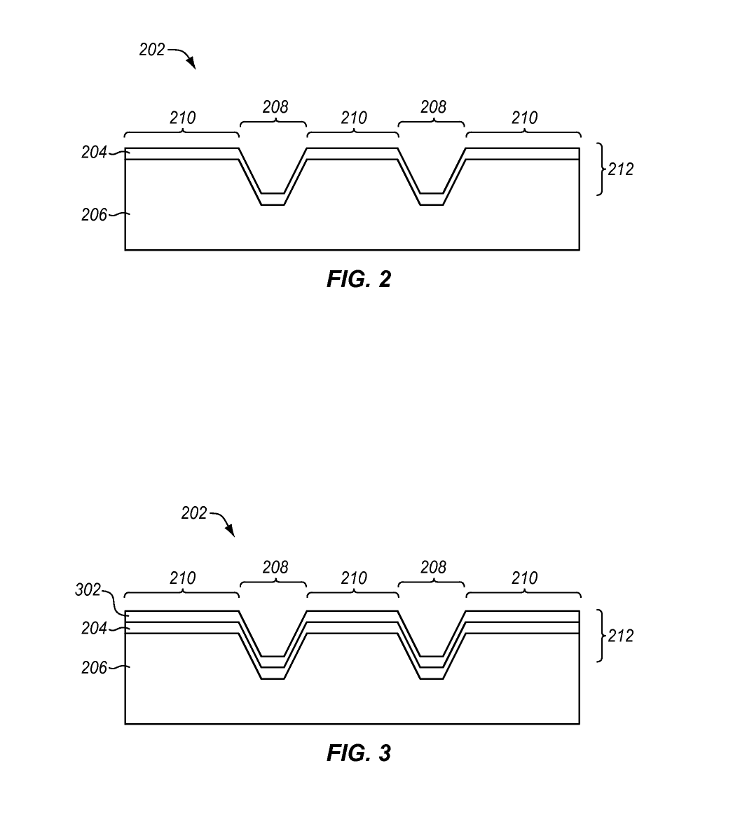

Step 102 is an optional step for method 100, which comprises depositing a protective layer on a patterned magnetic recording layer. FIG. 2 is a cross-sectional view illustrating a patterned magnetic recording disk 202 after depositing a protective layer 204 on a patterned magnetic recording layer 206. Protective layer 204 may include Diamond Like Carbon (DLC) or other protective layers, which act to protect a relatively soft magnetic recording layer 206 from damage. In this example, magnetic recording layer 206 is patterned on disk 202. Thus, FIG. 2 illustrates grooves 208 and lands 210 formed on disk 202 after a patterning process is performed on disk 202. When a patterning process is performed, grooves 208 may be created having a depth of up to about 20 nanometers into disk 202, as shown by depth 212. A variation between the top of lands 210 and the bottom of groves 208 as shown by depth 212 may modulate the clearance between read/write heads (not shown) and the surface of rotating disk 202, which degrades the quality of reading data from or writing data to disk 202.

Step 104 of FIG. 1 is an optional step for method 100, which comprises depositing a lubrication layer on protective layer 204. FIG. 3 is a cross-sectional view illustrating disk 202 after depositing a lubrication layer 302 on protective layer 204. Lubrication layer 302 acts to lubricate a slider (not shown) when the slider contacts the surface of disk 202 (e.g., when disk 202 is not rotating). Lubrication layer 302 may have a thickness of between about 0.5 nanometers and 2 nanometers. In some embodiments, lubrication layer 302 may comprise a non cross-linkable perfluoropolyether (PFPE) polymer. PFPE polymers are a class of materials that include a PFPE backbone coupled with functional end groups (and possibly functional side groups). In some cases, the end groups (or side groups) are cross-linkable by exposing the polymer to radiation, such as Ultra-Violet (UV) radiation. When a cross linkable polymer is exposed to UV, the end groups (or side groups) interconnect or cross-link. In other cases, the end groups (or side groups) are not cross-linkable. Thus, exposing the polymer to UV wavelengths typically used for cross-linking may have little effect on the fill polymers without cross-linkable groups. In some embodiments, depositing lubrication layer 302 is performed by dip coating disk 202.

Step 106 of FIG. 1 is an optional step for method 100, which comprises bonding lubrication layer 302 to protective layer 204. The bonding process may comprise exposing disk 202 to UV wavelengths that result in scission of the PFPE chains within the lubricant layer 302 to create radicals that react with the protective layer 204. Further, the bonding process may comprise exposing disk 202 to a thermal heating process to react the functional groups of lubrication layer 302 to protective layer 204. The bonding process does not cross-link the polymer, but rather forms strong covalent bonds between lubrication layer 302 and protective layer 204. Step 106 is performed to prevent the removal of lubrication layer 302 from lands 210 in subsequent processing steps, discussed below. Further, performing step 106 to bond lubrication layer 302 to protective layer 204 makes it easier to remove fill material 402 from the lands 210 prior to an optional bonding step.

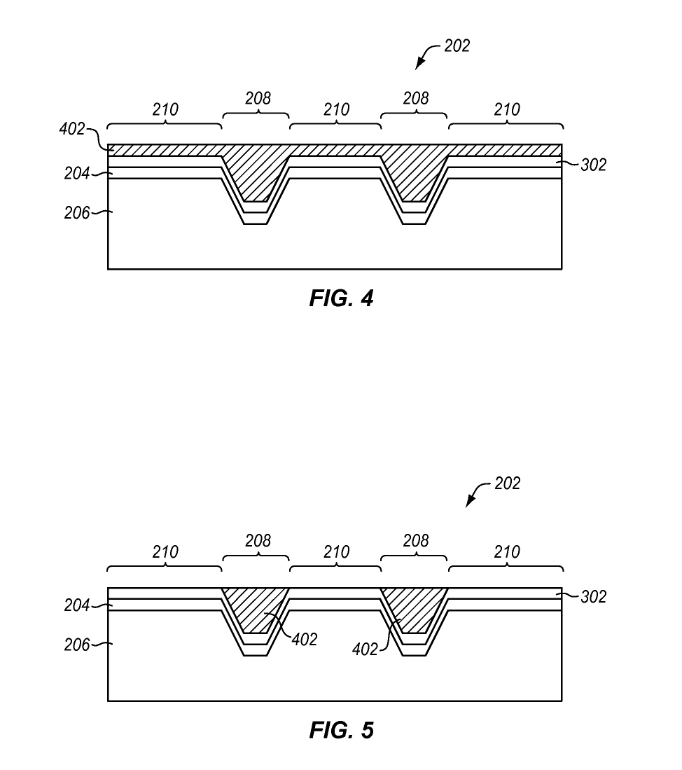

Step 108 comprises depositing a fill material on lubrication layer 302. FIG. 4 is a cross-sectional view illustrating disk 202 after depositing fill material 402 on lubrication layer 302. Fill material 402 comprises a polymer with a PFPE backbone, cross-linkable end groups (or side groups), and a urethane linkage between the PFPE backbone and the end (or side) groups. In some embodiments, the end groups (or side groups) may include di-acrylate or methyl-acrylate. Fill material 402 is deposited to overfill grooves 208 and cover lands 210 as illustrated in FIG. 4. In the embodiment described herein, the chemical structure of fill material 402 may be:

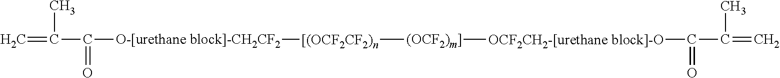

where the length of the PFPE backbone may vary such that the overall molecular weight of the polymer is between about 1,000 and 10,000 atomic mass units.

The urethane block is typically formed by reacting isocyanato ethyl methacrylate with the PFPE as a means of attaching the acrylate group to the polymer. The acrylate group can be made to undergo free radical polymerization with acrylate groups on adjacent polymer chains to form a cross-linked network or attachment to a media surface (e.g., lubricant layer 302) when exposed to UV. One advantage to adding the urethane block is that the polarity of the polymer, hence the compatibility with disk coatings, can be adjusted though the composition of the urethane block. Further compatibility can be achieved by using the appropriate acrylate subsistent R, where R is part of the chemical structure comprising

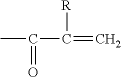

and where R is chosen from a group including H and CH₃ or other linear alkyl and/or aryl groups.

Another advantage to these types of PFPE-urethane-acrylate polymers is that the density after cross-linking, hence the modulus of fill material 402, can be controlled by the molecular weight of the polyether and the number of initial hydroxyl end groups per chain. Decreasing the polyol molecular weight or increasing the hydroxyl functionality of the starting polylol (e.g., 2, 4 . . . ) increases the cross-linked modulus and decreases the elongation at break and durability. In the embodiment described herein, the step of depositing fill material 402 may comprise dip coating disk 202.

Step 110 of FIG. 1 comprises performing a removal process on fill material 402 to planarize disk 202. FIG. 5 is a cross-sectional view illustrating disk 202 after performing the removal process. The removal process is used to remove fill material 402 from lands 210 between grooves 208 (e.g., to a residual thickness on lands 210 less than about 0.5 nanometers). Enough of fill material 402 is removed from grooves 208 in the removal process to render the remaining fill material 402 in grooves 208 essentially co-planar with the top of lubrication layer 302, as shown in FIG. 5. Typically, the top of the remaining fill material 402 in grooves 208 protrudes less than about 1 nanometer above the surface of lubrication layer 302, and recesses less than about 3 nanometers below the surface of lubrication layer 302. In the embodiment described herein, a mechanical process is used to remove the excess material from disk 202.

Step 112 of FIG. 1 is an optional step for method 100, which comprises bonding the remaining fill material 402 to lubrication layer 302. Disk 202 may be exposed to UV so that the end groups (or side groups) react, cross-linking the remaining fill material 402. Some of the end groups (or side groups) may also react with lubrication layer 302 and protective layer 204, bonding the remaining fill material 408 to the sides of grove areas 208. An abrasive mechanical process (e.g., a chemical mechanical polishing process) or an ion based process (e.g., plasma etch) may then be performed on disk 202 to remove fill material 402 that may remain in lands 210.

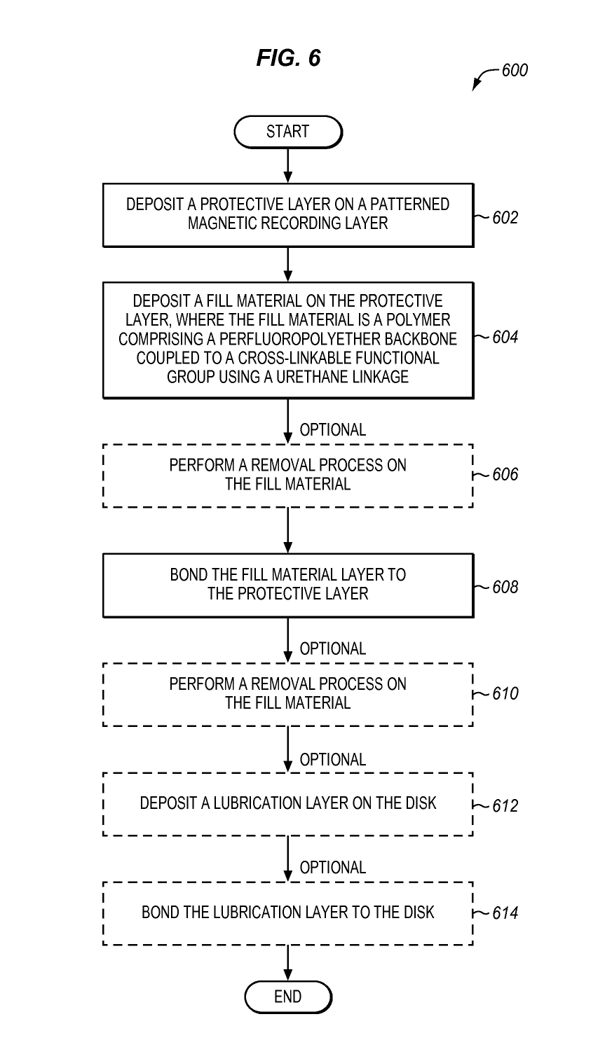

FIG. 6 is a flow chart illustrating an alternate method 600 of fabricating a patterned magnetic recording disk in an exemplary embodiment. While method 100 previously described depositing a fill material on a lubrication layer bonded to a disk, method 600 will describe depositing a lubrication layer on a fill material bonded to a disk.

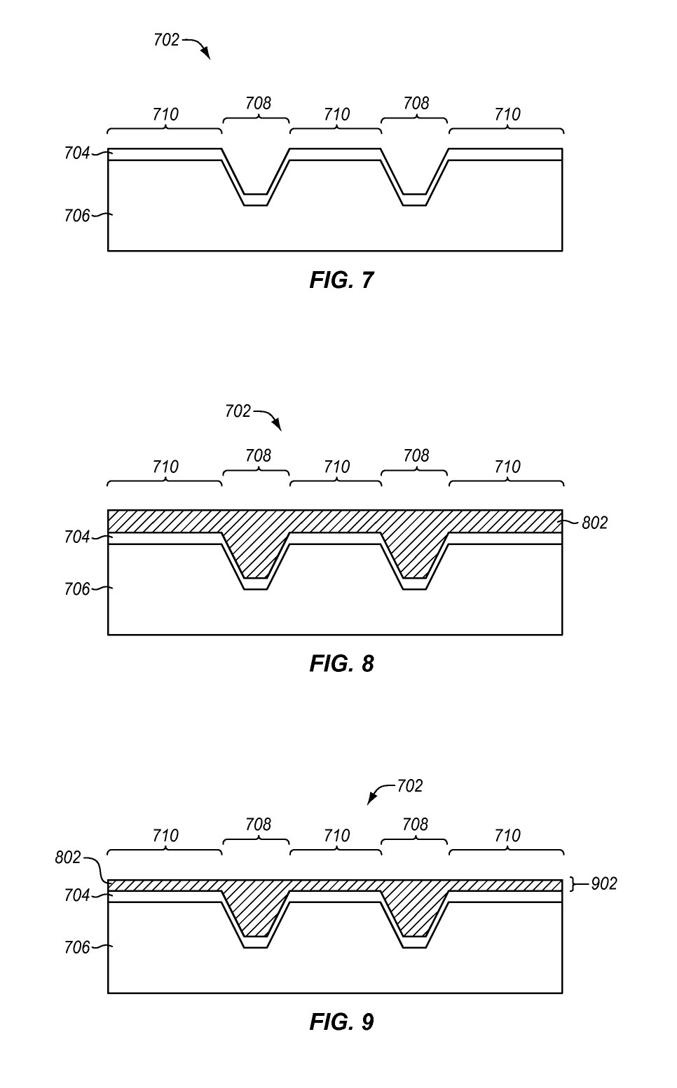

Step 602 comprises depositing a protective layer on a patterned magnetic recording layer. FIG. 7 is a cross-sectional view illustrating a patterned magnetic recording disk 702 after depositing a protective layer 704 on a patterned magnetic recording layer 706. FIG. 7 illustrates grooves 708 and lands 710, which may be formed after patterning disk 702. Step 604 of FIG. 6 comprises depositing a PFPE urethane acrylate polymer with cross-linkable end groups (or side groups) similar to the polymer discussed with regard to step 108 of method 100. FIG. 8 is a cross-sectional view illustrating disk 702 after depositing fill material 802 on protective layer 704.

Step 606 comprises performing an optional removal process to remove excess fill material 802 before bonding fill material 802 to protective layer 704. In some embodiments, excess fill material 802 is removed in step 606 before bonding fill material 802 to protective layer 704. In other embodiments, excess fill material 802 is removed after bonding fill material 802 to protective layer 704. FIG. 9 is a cross-sectional view illustrating disk 702 after excess of fill material 802 is optionally removed in step 606. After removing the excess fill material 802, fill material 802 may have a thickness 902 of between about 0 and 3 nanometers on lands 710. This may result in fill material 802 in lands 710 being essentially co-planar with fill material 802 in grooves 708 as shown in FIG. 9.

Step 608 of FIG. 6 comprises bonding remaining fill material 802 to protective layer 704. Disk 702 may be exposed to UV, which cross-links fill material 802. Some of the end groups (or side groups) also react with protective layer 704, bonding the remaining fill material 802 to the sides of grooves 708, and the top of lands 710.

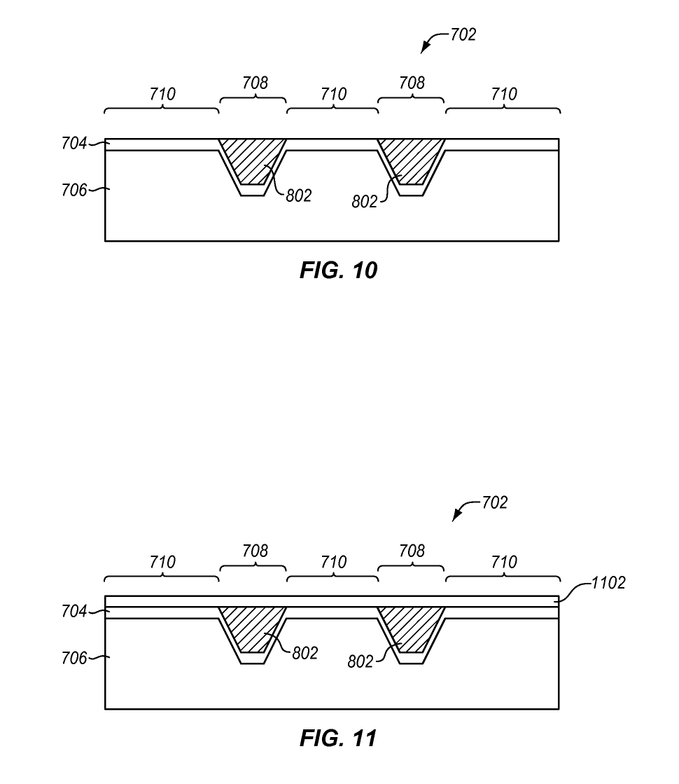

Step 610 comprises performing an optional removal process to remove excess fill material 802 after bonding fill material 802 to protective layer 704. As discussed with regard to step 606 above, removing excess fill material 802 may occur before step 608 or after step 608. Further, step 610 may be performed by an ion bombardment process applied to disk 702. FIG. 10 is a cross-sectional view illustrating disk 702 after excess of fill material 802 is optionally removed in step 610.

Step 612 of FIG. 6 comprises depositing an optional lubrication layer on disk 702, which covers fill material 802 in grooves 708, and covers protective layer 704 on lands 710. FIG. 11 is a cross-sectional view illustrating disk 702 after lubrication layer 1102 is optionally deposited on disk 702. Lubrication layer 1102 may be deposited to a thickness of between about 0.5 nanometers and 2 nanometers, and may comprise non-cross linkable polymer similar to the polymer discussed with regard to step 104 of method 100.

Step 614 of FIG. 6 is an optional step for method 600, which comprises bonding a portion of lubrication layer 1102 to disk 702 when step 612 occurs. Bonding lubrication layer 1102 may comprise exposing disk 702 to UV or a thermal heating process. The bonding process does not cross-link the lubricant, but rather forms strong covalent bonds between lubrication layer 1102 and protective layer 704, and also between lubrication layer 1102 and fill material 802. Bonding lubrication layer 1102 to disk 702 may reduce the loss of lubrication layer 1102. Typically, step 614 is controlled so that some of lubrication layer 1102 remains un-bonded, which helps maintain durability of disk 702.

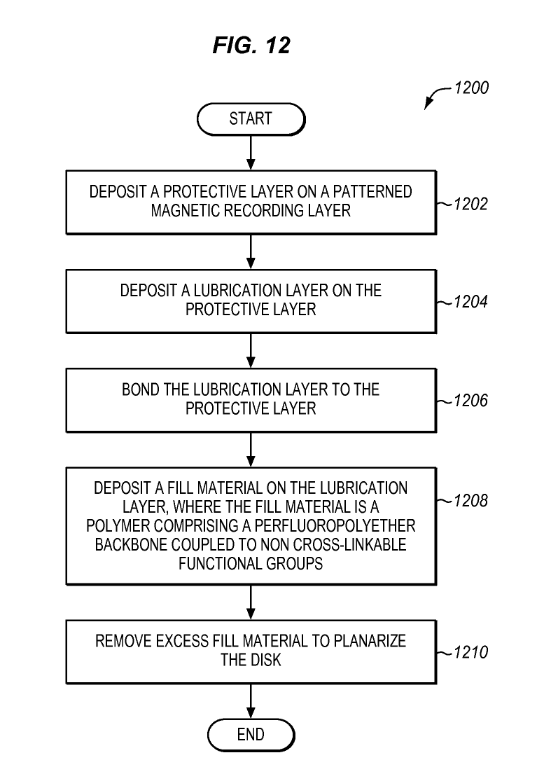

FIG. 12 is a flow chart illustrating an alternate method 1200 of fabricating a patterned magnetic recording disk in an exemplary embodiment. While method 100 previously described a fabrication process whereby the top surface of fill material 402 is substantially co-planar with the top surface of lubrication layer 302 (See FIG. 5), method 1200 will describe fabricating a disk such that a fill material remains on a lubrication layer after a removal process is performed on the fill material to planarize the disk. Further, the fill material of method 1200 comprises a PFPE backbone coupled with non cross-linkable functional groups.

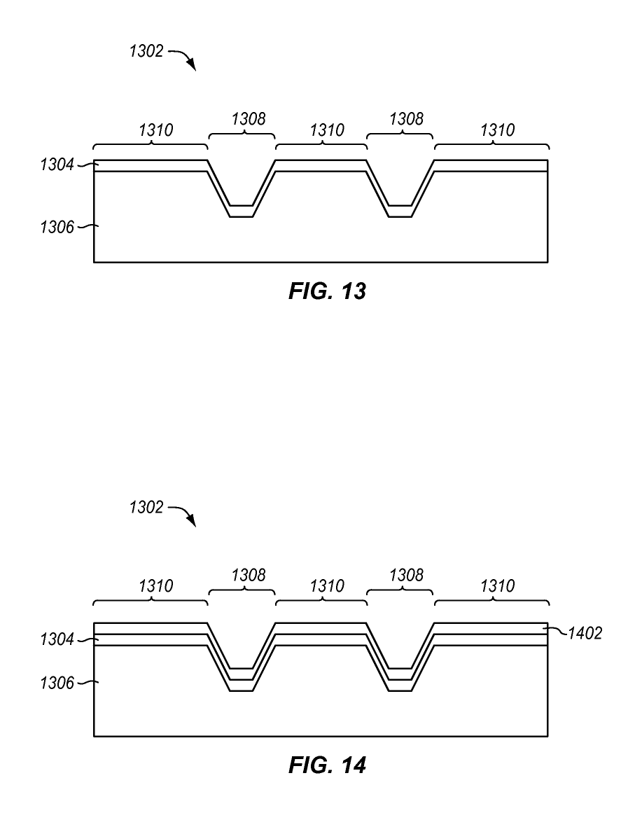

Step 1202 of FIG. 12 comprises depositing a protective layer on a patterned magnetic recording layer. FIG. 13 is a cross-sectional view illustrating a patterned magnetic recording disk 1302 after depositing a protective layer 1304 on a patterned magnetic recording layer 1306. FIG. 13 also illustrates grooves 1308 and lands 1310 formed on disk 1302 after a patterning process is performed on disk 1302.

Step 1204 of FIG. 12 comprises depositing a lubrication layer on protective layer 1304. FIG. 14 is a cross-sectional view illustrating disk 1302 after depositing a lubrication layer 1402 on protective layer 1304. Lubrication layer 1402 may comprise a non-cross linkable polymer similar to the polymer discussed with regard to step 104 of method 100 (See FIG. 1).

Step 1206 of FIG. 12 comprises bonding lubrication layer 1402 to protective layer 1304. Bonding lubrication layer 1402 may be performed in a manner similar to step 106 of method 100.

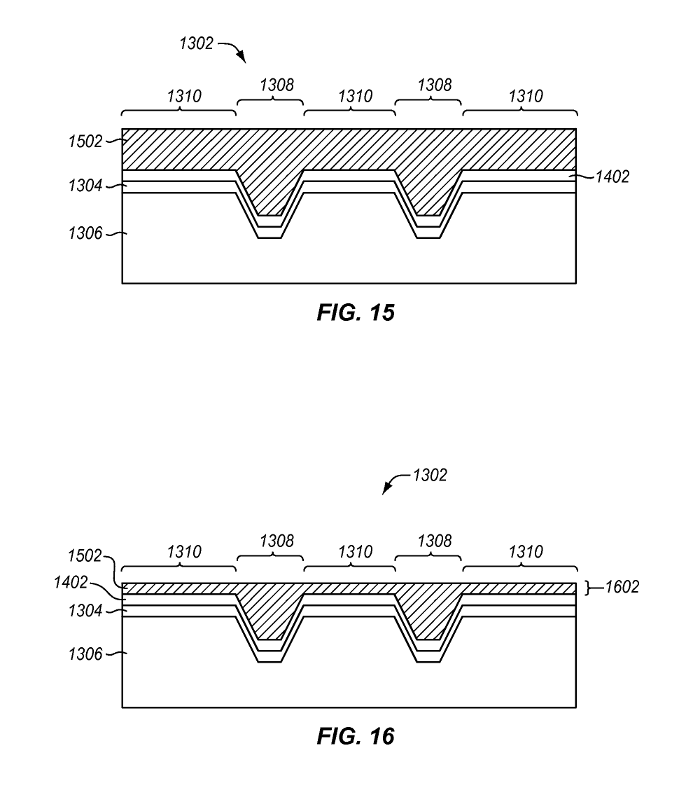

Step 1208 of FIG. 12 comprises depositing a fill material on lubrication layer 1402. FIG. 15 is a cross-sectional view illustrating disk 1302 after depositing fill material 1502 on lubrication layer 302. Fill material 1502 may comprise a non cross-linkable PFPE polymer called Demnum-Tetraol having a chemical structure of:

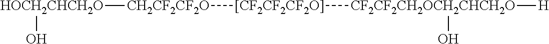

Fill material 1502 is considered a “free” PFPE polymer in this embodiment because fill material 1502 may not be bonded to lubricant layer 1402. Thus, fill material 1502 may readily be removed from disk 1302 by rinsing disk 1302 with a solvent.

Step 1210 comprises performing a process to remove an excess of fill material 1502 to planarize disk 1302. FIG. 16 is a cross-sectional view illustrating disk 1302 after performing the removal process. The removal process is used to planarize fill material 1502 in lands 1310 and grooves 1308 such that a residual thickness 1602 on lands 1310 less than about 1 nanometer. In FIG. 16, fill material 1502 covers the underlying lubrication layer 1402 and forms a continuous planar surface on disk 1302. In FIG. 16, fill material 1502 remains mobile on disk 1302, enabling fill material 1502 to flow out onto lands 1310 and replenish loss of lubrication due to occasional head to disk contact.

Although specific embodiments were described herein, the scope of the invention is not limited to those specific embodiments. The scope of the invention is defined by the following claims and any equivalents thereof.

We claim:

1. A method of fabricating a patterned magnetic recording disk, the method comprising:
depositing a fill material on the magnetic recording disk, wherein the fill material is a polymer comprising a perfluoropolyether (PFPE) backbone coupled to at least one of a cross-linkable end group and a cross-linkable side group using a urethane linkage; and
performing a removal process on the fill material to planarize the magnetic recording disk.

2. The method of claim 1 further comprising:
depositing a protective layer on a patterned magnetic recording layer; and
depositing a lubrication layer on the protective layer;
bonding the lubrication layer to the protective layer,
wherein depositing the fill material further comprises:
depositing the fill material on the lubrication layer.

3. The method of claim 2 further comprising:
bonding the fill material to the lubrication layer by exposing the disk to ultra-violet light to cross-link the at least one of the end group and the side group.

4. The method of claim 2 wherein bonding the lubrication layer further comprises:
bonding the lubrication layer to the protective layer using at least one of an ultra-violet bonding process and a thermal bonding process.

5. The method of claim 2 wherein depositing the lubrication layer further comprises:
depositing the lubrication layer to a thickness of between about 0.5 nanometers to 2 nanometers.

6. The method of claim 1 wherein the fill material is a PFPE-urethane-acrylate polymer.

7. The method of claim 1 wherein the fill material is a PFPE polymer having a chemical structure of:

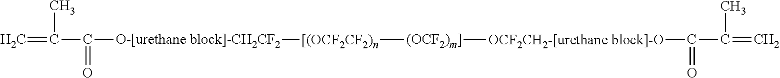

8. The method of claim 1 further comprising:
depositing a protective layer on a patterned magnetic recording layer,
wherein depositing the fill material further comprises:
depositing the fill material on the protective layer;
bonding the fill material to the protective layer; and
performing a removal process on the fill material to planarize the magnetic recording disk.

9. The method of claim 8 further comprising:
depositing a lubrication layer on the planarized magnetic recording disk; and
bonding the lubrication layer to the fill material using at least one of an ultra-violet bonding process and a thermal bonding process.

10. The method of claim 8 wherein performing a removal process further comprises:
performing at least one of a plasma etch process and an ion bombardment process on the fill material to planarize the magnetic recording disk.

11. The method of claim 8 further comprising:
removing an excess of fill material deposited on the protective layer before bonding the fill material to the protective layer.

12. A patterned magnetic recording disk comprising:
a fill material on a patterned surface of the magnetic recording disk, wherein the fill material is a polymer comprising a Perfluoropolyether (PFPE) backbone coupled to at least one of a cross-linkable end group and a cross-linkable side group using a urethane linkage.

13. The magnetic recording disk of claim 12 further comprising:
a patterned magnetic recording layer having grooves and lands;
a protective layer on the patterned magnetic recording layer; and
a lubrication layer on the protective layer, wherein the lubrication layer is bonded to the protective layer, and wherein the fill material is on the lubrication layer.

14. The magnetic recording disk of claim 13 wherein the fill material in the grooves of the magnetic recording disk is substantially co-planar with the lubrication layer on the lands of the magnetic recording disk.

15. The magnetic recording disk of claim 13 wherein the fill material is bonded to the lubrication layer.

16. The magnetic recording disk of claim 12 wherein the fill material is a PFPE-urethane-acrylate polymer.

17. The magnetic recording disk of claim 12 wherein the fill material is a PFPE polymer having a chemical structure of:

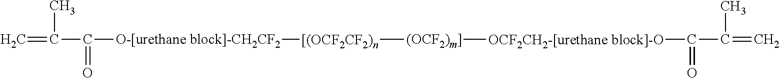

18. The magnetic recording disk of claim 12 further comprising:
a patterned magnetic recording layer having grooves and lands; and
a protective layer on the patterned magnetic recording layer,
wherein the fill material is on the protective layer.

19. The magnetic recording disk of claim 18 wherein the fill material in the grooves of the magnetic recording disk is substantially co-planar with the protective layer on the lands of the magnetic recording disk.

20. The magnetic recording disk of claim 18 further comprising:
a lubrication layer on the fill material and on the protective layer.

21. The magnetic recording disk of claim 20 wherein the lubrication layer is bonded to the fill material.

22. The magnetic recording disk of claim 20 wherein the lubrication layer has a thickness of between about 0.5 nanometers and 2 nanometers.

23. A method of fabricating a patterned magnetic recording disk, the method comprising:
depositing a protective layer on a patterned magnetic recording layer;
depositing a lubrication layer on the protective layer;
bonding the lubrication layer to the protective layer;
depositing a fill material on the lubrication layer, wherein the fill material is a polymer comprising a Perfluoropolyether (PFPE) backbone coupled to non-cross-linkable functional groups; and
performing a removal process on the fill material to planarize the magnetic recording disk.

24. The method of claim 23 wherein the fill material is a PFPE polymer having a chemical structure of: [chemical structure]
